(19) United States
(12) Patent Application Publication
(10) Pub. No.: US 2005/0278331 A1
(43) Pub. Date: Dec. 15, 2005

(54) Information management apparatus, information management method and program

(75) Inventor: Kenji Hatori, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/142,193

(22) Filed: Jun. 2, 2005

(30) Foreign Application Priority Data
Jun. 9, 2004 (JP) 2004-171772

(51) Int. Cl. G06F 7/00

(52) U.S. Cl. 707/7

(57) ABSTRACT

An information management apparatus which manages information files by sorting them into folders, comprises a selection unit to select an arbitrary folder and a folder operation unit capable of individually opening/closing a sub folder immediately below the selected folder or in a lower layer.

### FIELD OF THE INVENTION

The present invention relates to a technique for managing information files such as image files by sorting them into folders.

### BACKGROUND OF THE INVENTION

Conventionally, for storage of many information files such as image data, audio data and character data on a computer, assortment of files by placing related files in the same folder is widely performed. For example, Explorer (registered trademark) used by Windows (registered trademark) by Microsoft Corporation generates layered folders to store files. When a folder is selected, thumbnail images or the like of files in the folder are displayed (Japanese Patent Application Laid-Open Nos. 11-96194, 2003-316628 and 2003-108976).

However, in the conventional method, since only the files and folders included in one (selected) folder are displayed, if a desired file is not included in a selected folder, a procedure of selecting another folder and searching for the file is repeated. Further, to compare the contents of plural folders, it is necessary to open plural windows.

### SUMMARY OF THE INVENTION

The present invention has been made in consideration of the above problems, and has its object to provide an information management technique for facilitation of information retrieval in each of plural folders.

To address the above problems and attain the object, the present invention provides an information management apparatus for managing information files by sorting the information files into folders, comprising: selection means for selecting an arbitrary folder; and folder operation means for individually opening/closing a sub folder immediately below the selected folder or in a lower layer.

Further, the present invention provides an information management method for managing information files by sorting the information files into folders, comprising: a selection step of selecting an arbitrary folder; a folder operation step of opening/closing the selected folder; a sub folder selection step of individually selecting a sub folder immediately below the selected folder or in a lower layer; and an opening/closing step of individually opening/closing the selected sub folder.

Note that the present invention is applicable as a program for performing the above information management method by a computer or a storage medium holding the program.

As described above, according to the present invention, information retrieval in each of plural folders is facilitated.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a functional block diagram showing the construction of an information management apparatus according to an embodiment of the present invention;

FIG. 2 is an example of screen image displayed by the information management apparatus according to the embodiment;

FIG. 3 is a flowchart showing processing upon folder selection;

FIG. 4 is an example of screen image showing folder representative images, the number of images and comments;

FIG. 5 is a flowchart showing processing when a folder is opened;

FIG. 6 is an example of screen image when the folder is opened;

FIG. 7 is an example of screen image when a lateral scroll bar is displayed;

FIG. 8 is a flowchart showing processing for displaying the lateral scroll bar;

FIG. 9 is a flowchart showing processing when a folder is closed;

FIG. 10 is a flowchart showing processing when only images immediately below the folder are turned to a nondisplayed state;

FIG. 11 is a flowchart showing processing when a thumbnail of an image is selected;

FIG. 12 is a flowchart showing processing when an image is deleted;

FIG. 13 is a flowchart showing processing when a preview image is displayed;

FIG. 14 is a flowchart showing retrieval processing;

FIG. 15 is an example of screen image when folders lower than a higher holder are displayed;

FIG. 16 is an example of screen image when two folders are displayed in parallel;

FIG. 17 is a flowchart showing processing when plural folders are selected; and

FIG. 18 is an example of screen image when only images immediately below a folder are turned to a nondisplayed state.

### DETAILED DESCRIPTION OF THE PREFERRED EMBODIMENT

Hereinbelow, a preferred embodiment of the present invention will now be described in detail in accordance with the accompanying drawings.

Note that the following embodiment is an example of implementation of the present invention but may be appropriately corrected or changed in accordance with apparatus construction or various conditions to which the present invention is applied. The present invention is not limited to the following embodiment.

Further, the present invention is also attained by providing a storage medium (or recording medium) holding software program code for realizing the functions of an information management apparatus as an embodiment to be described later to a system or an apparatus, reading the program code with a computer (e.g., CPU, MPU) of the system or apparatus from the storage medium, then executing the program.

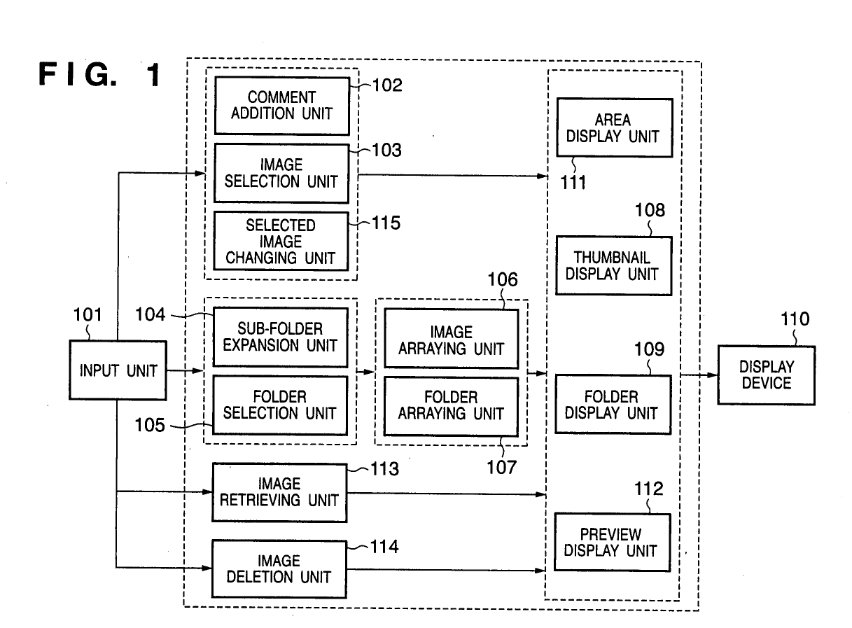

FIG. 1 is a functional block diagram showing the construction of an information management apparatus according to an embodiment of the present invention.

In FIG. 1, reference numeral 101 denotes an input unit such as a keyboard or a mouse; 110, a display device such as a CRT; 109, a folder display unit which displays information on a folder such as a name and an icon of the folder selected by a user; and 108, a thumbnail display unit which displays a thumbnail (reduced image) of an image included in a folder. The folders and images are recorded on a recording medium such as a hard disk (not shown). The thumbnails are previously generated or generated upon display. Numeral 111 denotes an area display unit which determines an area where the folders and images are displayed, and displays the area and buttons for operations related to the area. Numeral 112 denotes a preview display unit which displays an enlarged image in another area. The preview display unit 112 reads, not a thumbnail but an original image, reduces or enlarges the image in accordance with a predetermined size, and displays the image in a preview area 223 to be described later. Numeral 105 denotes a folder selection unit which selects a folder from which images are to be displayed. The user designates a folder displayed in a tree area 200 to be described later using the input unit 101, thereby designates the folder from which images are to be displayed.

In the present embodiment, the folder selection unit 105 is capable of selecting plural folders. Numeral 104 denotes a sub-folder expansion unit which expands or closes a sub folder in a currently-displayed folder designated by the user from the input unit 101. When a sub folder is expanded, thumbnails of images included in the sub folder are displayed, while when the sub folder is closed, thumbnails of representative images in the folder are displayed. Numeral 106 denotes an image arraying unit which arrays images immediately below a selected folder or images immediately below an expanded sub folder. The arrayed images are displayed by the image display unit 112 on the display device 110. Numeral 107 denotes a folder arraying unit which arrays sub folders included in a selected folder. The arrayed folders are displayed by the display unit 112 on the display device 110. Numeral 103 denotes an image selection unit which selects image(s) displayed by the image display unit 112 in an image list display area 220 to be described later. The selected image(s) is turned by the image display unit 112 to a selected state. Numeral 115 denotes a selected image changing unit which releases the selected state of the image(s) selected by the image selection unit 103, and turns the next or previous image, in the order of currently arrayed images, to the selected state. As a particular image order, the order of file names, the order of date and time of image sensing and the like can be used.

As a particular user operation, depression of rightward or leftward arrow key on a keyboard is conceivable. In a case where the last image in one folder is selected, when selection of the next image is requested by the selected image changing unit 115, the head image in the next folder is selected. Similarly, in a case where the head image in one folder is selected, when selection of the previous image is requested by the selected image changing unit 115, the last image in the previous folder is selected. The selected image changing unit 115 enables sequential display of images in a preview area 223 to be described later. Numeral 102 denotes a comment addition unit which adds a comment to a folder. The added comment is displayed by the folder display unit 109 on the display device 110. Numeral 113 denotes an image retrieving unit which retrieves image(s) with a keyword, an attribute or the like as a key. More particularly, the image retrieving unit 113 retrieves an image satisfying a condition from the recording medium such as a hard disk (not shown). Numeral 114 denotes an image deletion unit which deletes an image in selected state at that time. More particularly, the image deletion unit 114 deletes the image from the recording medium such as a hard disk (not shown). The elements 102 to 113 are realized as software on a computer.

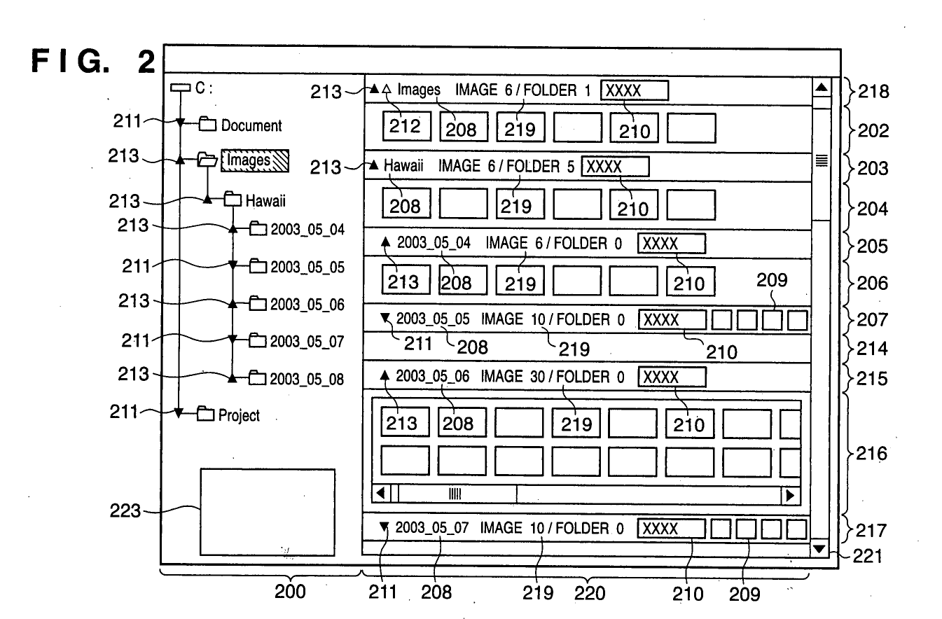

FIG. 2 is an example of screen image displayed by the information management apparatus according to the present embodiment.

In the screen image, a folder “Hawaii” exists as a lower folder of a folder “Images”. The folder “Hawaii” includes “2003_{—}05_{—}04” to “2003_{—}05_{—}08” folders. The user selects the folder “Images”.

The hierarchical structure of the folders on the computer is displayed in the tree area 200. In this example, the folder “Images” which is currently selected is inverted. The currently-selected folder and thumbnails of images in lower folders are displayed in the image list display area 220. In this example, a vertical directional scroll bar 221 is displayed since all the images in the lower folders cannot be displayed.

Numerals 203, 205, 207, 215 and 217 denote areas where a name, a comment, representative images, the number of images and the number of folders in a sub folder of a currently-selected folder are displayed. These items are indented in accordance with the folder hierarchical structure. This display enables the user to easily grasp the hierarchical structure. Numeral 208 denotes a sub folder name; 210, a comment to the folder; and 209, representative images of the folder. As representative images, for example, 4 images are selected from images arrayed in the order of file name, the order of date and time of image sensing, the order of date and time of file update, the order of file size, or the order of file type. The array order is selected by the user, further, thumbnail array order in the image list display area 220 may be interlocked with the selected array order. Further, ascending order/descending order may be designated. Numeral 219 denotes the number of images and the number of folders included in the folder.

Numerals 211 and 213 denote folder opening/closing buttons. The folder opening/closing buttons exist in the tree area 200 and the image list display area 220. Folder opening/closing can be made by using any one of these buttons. When a folder is opened, thumbnails immediately below the folder and sub folders existing as lower folders are displayed. The sub folders are displayed in the tree area 200. When the folder is closed, the thumbnails immediately below the folder and the sub folders as lower folders are not displayed but representative images immediately below the folder are displayed in the image list display area 220. No sub folder is displayed on the tree area 200. In this arrangement, thumbnails in only a folder to be browsed are displayed, but a folder not to be browsed is closed. The user can guess the contents of the folder using this arrangement. In the areas 203, 205 and 215, the folder is opened, while in the areas 207 and 217, the folder is closed.

Numeral 218 denotes a folder display area showing a name of a currently-selected folder (“Images” in FIG. 2), a comment, representative images, the number of images and the number of folders. Numeral 212 denotes a selected folder opening/closing button to display thumbnail(s) of image(s) immediately below a selected folder or turn them to a nondisplayed state. In FIG. 2, the thumbnails are displayed, but if the button is operated, the thumbnails displayed in the image list display area 220 are turned to a nondisplayed state, then representative images are displayed instead. Note that different from the buttons 211 and 213 for opening/closing sub folders, the button 212 is not used for opening/closing the sub folders. In FIG. 2, even when the button 212 is operated, the area 203 and the lower areas are displayed thereafter. In a case where the number of images immediately below a selected folder is large and sub folder areas (203, 205, 207, 215 and 217) cannot be displayed in the screen image, images immediately below the folder are turned to a nondisplayed state, thereby the scrolling of the screen image with the scroll bar can be omitted.

Numerals 202, 204, 206, 214 and 216 denote thumbnail display areas where thumbnails of images are displayed. The thumbnails are displayed regarding only folders opened with the buttons 211, 212 and 213. In a case where the number of images included in the opened folder is small, all the thumbnails of images are displayed as shown in the areas 202, 204 and 206. In a case where the number of images is large, the images are arrayed in a predetermined number of lines. In the area 216, the thumbnails are displayed in two lines. Further, a scroll bar 222 is displayed in a lateral direction so as to display thumbnails which cannot be displayed in the area. Since the scroll bar 221 exists in the vertical direction, the scroll bar 222 is a lateral scroll bar. As the scrolling in different direction, when an upward/downward arrow key on the keyboard or a vertical wheel of the mouse is operated, the entire screen image can be moved in a vertical direction as if the vertical scroll bar is operated. When a rightward/leftward arrow key is operated, the screen image can be moved in a lateral direction as if the lateral scroll bar is operated. That is, an area to be moved can be uniquely determined in accordance with the direction designated by the user.

The thumbnails displayed in the image list display area 220 can be arbitrarily selected, thus only a desired image can be selected and print-outputted. The preview area 223 is used for image display. For the sake of more excellent view, an image selected in the image list display area 220 is enlarged and displayed in the preview area 223.

Next, the processing according to the present embodiment will be described.

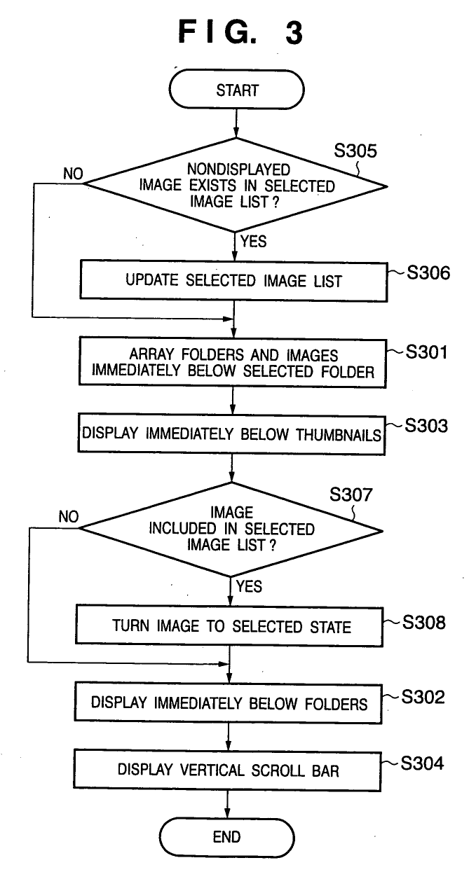

FIG. 3 is a flowchart showing processing when the user has selected a folder.

When the user selects a folder using the input unit 101, the folder selection unit 105 detects the selection, and at step S305, the folder arraying unit 107 determines whether or not images included in a selected image list exist in a lower layer of the currently-selected folder. If there is an image not existing in the lower layer, the image is deleted from the selection image list at step S306.

The selection image list holds a list of images in a selected state. In the present embodiment, when a folder including a selected image is closed and then the folder is opened again, the selected image is again in the selected state. For this purpose, the selected image list is referred to when a folder is opened, thereby the selected image is displayed in the selected state. In this arrangement, it is unnecessary for the user, who closed a folder, to select a once-selected image again. The selected image list holds full path names of files, each for uniquely determining the location of each image file. The purpose of the processing at step S306 is, when the user newly selects a folder, if a folder including a previously-selected image is not displayed, to delete the image in the nondisplayed folder from the selected image list, thereby avoiding display of the image, non-displayed in the image list display area 220, in a selected state. For example, when images are selected and deleted, only an image included in a currently-displayed folder is deleted without erroneously deletion of an image included in an non-displayed folder.

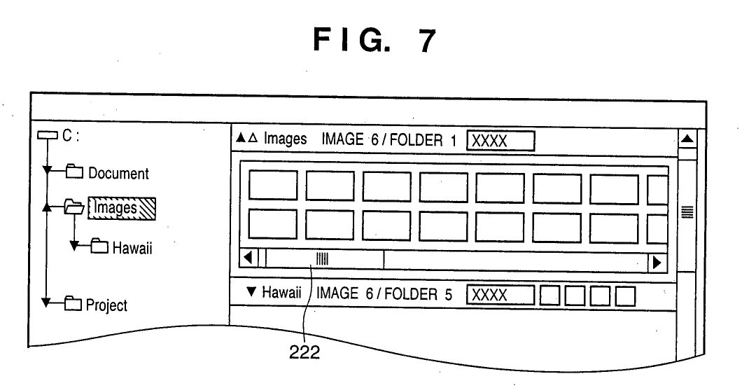

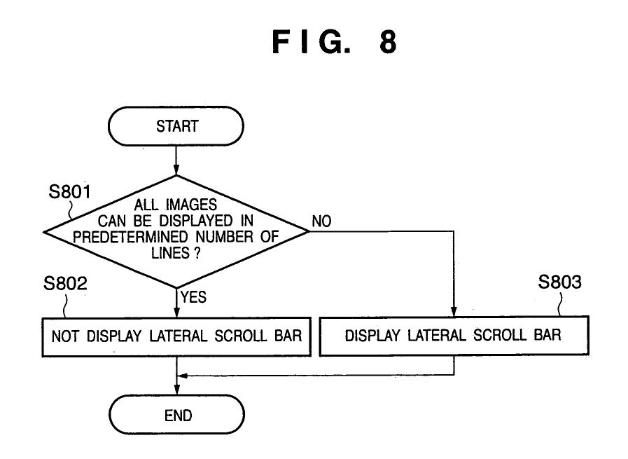

If there is no non-displayed folder at step S305, otherwise after step S306, then, the image arraying unit 106 arrays images immediately below the selected folder at step S301. In FIG. 2, when the user selects the folder “Images”, the folder “Hawaii” and 6 images immediately blow the folder “Images” are arrayed. Next, at step S303, the thumbnail display unit 108 displays thumbnails of the arrayed images. At this time, if the number of the thumbnails is large, the scroll bar 222 is displayed in the lateral direction as shown in FIG. 7. This processing will be described with reference to the flowchart of FIG. 8.

At step S801, it is determined whether or not all the thumbnails of the images can be displayed in a predetermined number of lines. If all the thumbnails cannot be displayed, the lateral scroll bar is displayed at step S803, while if all the thumbnails can be displayed, the lateral scroll bar is not displayed. The predetermined number of lines is set in accordance with the user's preference. If the number of lines is set to a large number, the number of thumbnails displayable at once per one folder is increased. However, a wide vertical display area is required. If the number of lines is set to a small number, though the vertical display area is small, lateral scrolling is required for browsing all the thumbnails.

Returning to FIG. 3, at step S307, it is determined whether or not thumbnails of displayed images are included in the selected image list. If they are included in the list, the images are turned to a selected state. Thus the previously-selected images are turned in the selected state again.

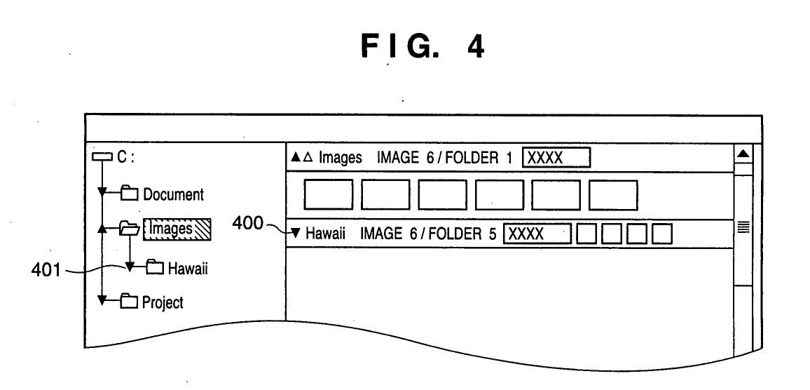

Next, at step S302, the folder display unit 109 displays the arrayed folders. At that time, the folders are in a closed state, and representative images of the folders, the numbers of images and comments are displayed as shown in FIG. 4. Next, at step S304, when the number of folders or images immediately below the selected folder is large and the folders or images cannot be displayed in the current display area, a scroll bar is displayed in the vertical direction. In FIG. 4, as the number of folders or images immediately below the selected folder is small, a scroll bar is not displayed.

Next, processing when the user opens a folder will be described.

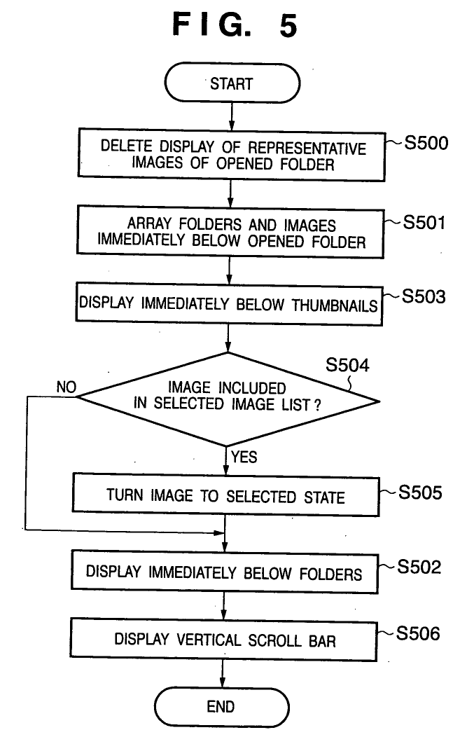

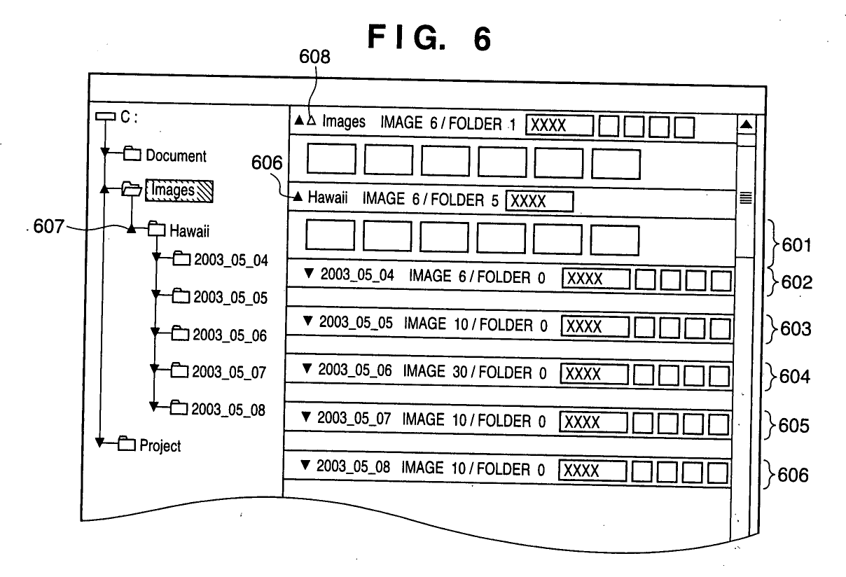

For example, in FIG. 4, the processing corresponds to opening of the folder “Hawaii” which is closed in the default setting. The folder can be opened by using folder opening and closing buttons 400 and 401 in FIG. 4. FIG. 6 shows the example of the screen image when the folder “Hawaii” is opened. This function is used when images in other folder(s) are browsed. In the present embodiment, a particular folder can be opened while other folder(s) are opened. The operation at this time will be described with reference to the flowchart of FIG. 5. In FIG. 5, when the user opens a folder using the input unit 101, then at step S500, the folder selection unit 105 detects the opening, and the folder display unit 109 deletes display of the representative images displayed by that time. Next, at step S501, the folder selection unit 105 detects the deletion, then the folder arraying unit 107 arrays folders immediately below the selected folder, and the image arraying unit 106 arrays images immediately below the selected folder. Next, at step S503, thumbnails of the images immediately below the opened folder are displayed as shown in an area 601 in FIG. 6. At step S504, it is determined whether or not the images displayed at step S503 are included in the selected image list. If they are included in the selected image list, the thumbnails of the images are turned to a selected state. As described above, in the present embodiment, an image can be turned to a selected state, and if a folder including the image is closed and then opened again, the image is again displayed in the selected state. Next, at step S502, the folder display unit 109 displays the arrayed folders. At this time, as shown in areas 602 to 606 in FIG. 6, the folders are displayed with rightward indentation such that the user can grasp the hierarchical relation of the folders. Further, the folders are displayed in a closed state, and representative images of the folders, the numbers of images, and comments are displayed. Next, at step S506, if the number of folders or images immediately below the selected folder is large and the folders or images cannot be displayed in the current display area, a scroll bar is displayed in the vertical direction.

Next, processing when a folder is closed will be described.

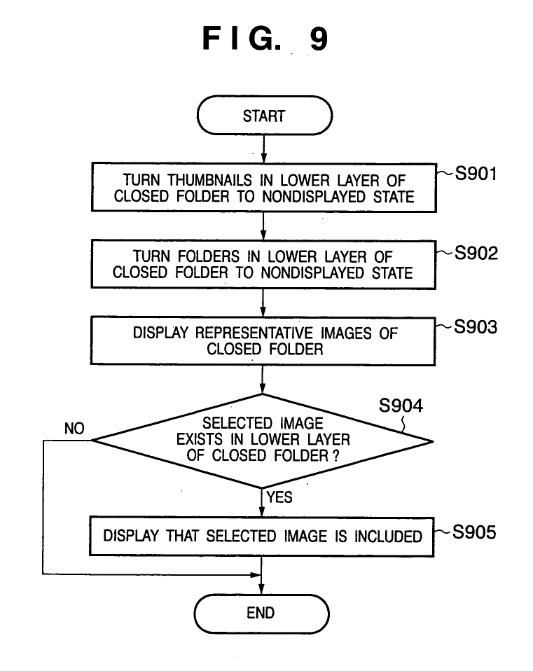

This processing corresponds to changing the state in FIG. 6 to that in FIG. 4. This operation is performed by using folder opening and closing buttons 606 and 607 in FIG. 6. This function is effective when the number of images in a particular folder is large and images in other folder(s) cannot be displayed if the images in the particular folder are displayed. The processing will be described with reference to the flowchart of FIG. 9. In FIG. 9, when the user closes a folder using the input unit 101, then at step S901, the folder selection unit 105 detects the closing, and the thumbnail display unit 108 turns thumbnails of images included in a lower layer of the closed folder to a nondisplayed state. Further, at step S902, the folder display unit 109 turns folders included in lower layers of the closed folder to a nondisplayed state. In the present embodiment, as the lower folders can be sequentially opened, when one folder has been closed, folders and thumbnails in lower layers as well as folders and thumbnails immediately below the closed folder are turned to a nondisplayed state. Next, at step S903, the folder display unit 109 displays a representative image of the closed folder. Next, at step S904, it is determined whether or not an image in a selected state exists in any of lower layers of the closed folder. If it is determined that an image in a selected state exists, the process proceeds to step S905 at which the folder display unit 109 changes the display form of folder display area by, e.g., changing the color of the folder display area or displaying a special icon, so as to indicate that a selected image exists.

Next, processing when only image(s) immediately below the folder is turned to a nondisplayed state will be described.

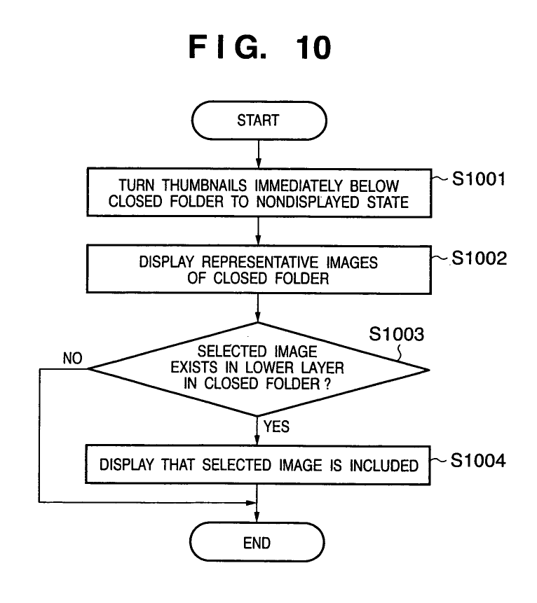

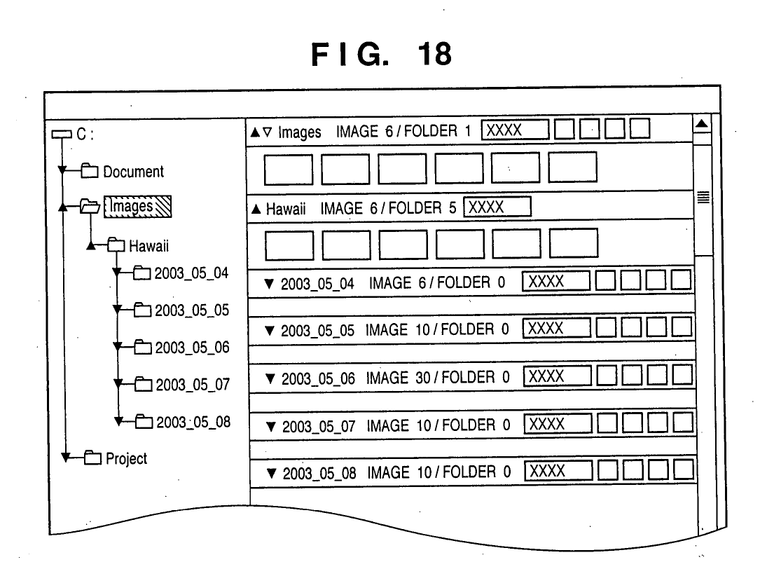

This processing corresponds to changing from the state in FIG. 6 to that in FIG. 18. This operation is performed by using a selection folder opening and closing button 608 in FIG. 6. This function is effective when the number of images in a particular folder is large and sub folders below the folder are displayed in a lower position of the window. FIG. 10 shows a flowchart of the processing. In FIG. 10, when the user closes a folder using the input unit 101, then at step S1001, the folder selection unit 105 detects the closing, and the thumbnail display unit 108 turns thumbnails of images immediately below the closed folder to a nondisplayed state. Next, at step S1002, representative images of the closed folder are displayed. At step S1003, it is determined whether or not an image in a selected state exists immediately below the closed folder. If it is determined that an image in a selected state exists, the process proceeds to step S1004 at which the folder display unit 109 changes the display form of folder display area by, e.g., changing the color of the folder display area or displaying a special icon, so as to indicate that a selected image exists.

Next, processing when a thumbnail of an image is selected will be described.

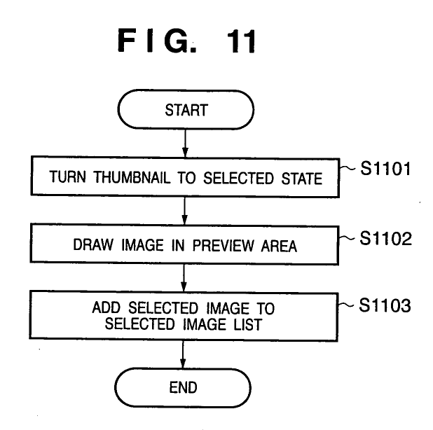

This processing corresponds to an operation performed upon selection of a desired image prior to e.g. image printing. The processing will be described with reference to the flowchart of FIG. 11. When the user selects an image using the input unit 101, then at step S1101, the folder selection unit 105 detects the selection, and the thumbnail display unit 108 turns a thumbnail of the selected image to a selected state. As a method for changing an image state to a selected state, changing a color of periphery of thumbnail or the like is used. Next, at step S1102, the preview display unit 112 displays the selected image in the preview area 223. At this time, an image larger than the thumbnail, obtained by e.g. reading an original image, is displayed. At step S1103, the thumbnail display unit 108 adds the selected image to the selected image list. As described above, the list holds a list of images in a selected state.

Next, processing when an image is deleted will be described.

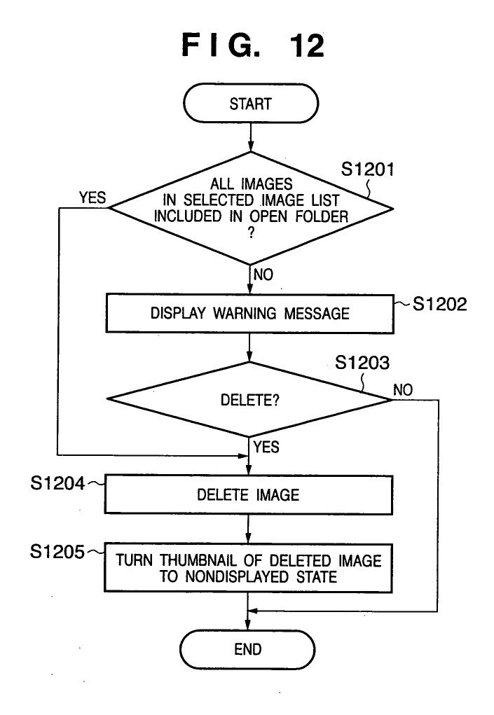

FIG. 12 is a flowchart showing processing when an image has been deleted. In the present embodiment, an image to be deleted is selected before deletion. That is, an image included in the selected image list is deleted. When the user requests deletion of an image using the input unit 101, then at step S1201, the image deletion unit 114 examines whether or not all the images included in the selected image list are included in an open folder (unclosed folder). If the images are included only in an open folder, the image deletion unit 114 deletes the images and empties out the selected image list at step S1204. Further, at step S1205, the thumbnail display unit 108 turns thumbnails of the deleted images to a nondisplayed state. If it is determined at step S1201 that there is an image included in a closed folder, a warning is made about deletion of an image included in a closed folder at step S1202, for the user's checking whether the deletion is to be made or not. As an image included in a closed folder is not displayed, the user may overlook the deletion of such image. In the present embodiment, to prevent inconvenient deletion of such image, a warning message is displayed. If deletion is to be made, deletion is performed at the above-described steps S1204 and S1205, while if deletion is not to be made, the deletion operation is ended without deletion.

Next, processing when an image is displayed on the preview display unit will be described.

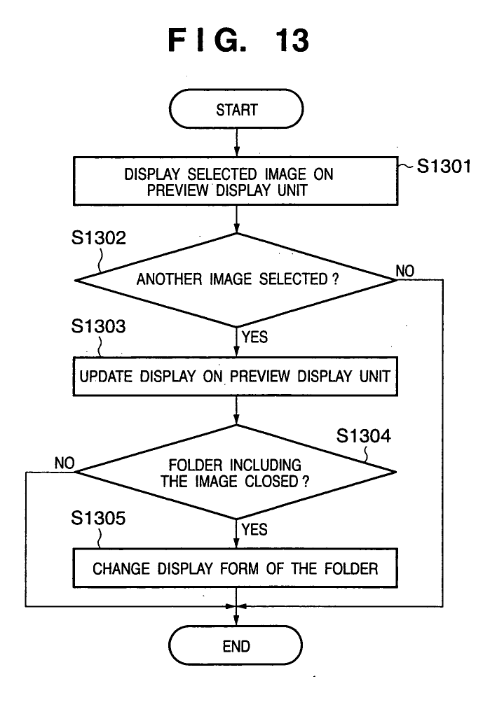

FIG. 13 is a flowchart showing processing when a preview image is displayed on the preview display unit 112. At step S1301, the preview display unit 112 displays an image corresponding to a currently-selected thumbnail. Next, at step S1302, when another image is selected by the image selection unit 103 or the selected image changing unit 115, the preview display unit 112 displays the selected image at step S1303. Next, at step S1304, it is determined whether or not a folder including the selected image is closed. If it is determined that the folder is closed, the folder display unit 109 displays the folder in different form from that of other folders by changing color, flash-displaying or the like. This operation occurs when an image in another folder is selected by the selected image changing unit 115. More particularly, the operation occurs when a selected image is changed by depressing an arrow key of the keyboard. For example, in a case where only one image included in a folder is selected and then a rightward arrow key is depressed, an image included in the next folder is turned to a selected state. If the next folder is closed, as thumbnails in the folder are not displayed, the user does not know the folder and the currently selected image. To address this problem, the folder including the selected image is displayed in a different form from that of other folders. Otherwise, it may be arranged such that the selected image is displayed as a folder representative image 209. Otherwise, the selected image changing unit 115 may select only an image included in an open folder in the image list display area 220. This prevents automatic selection of image included in a closed folder by the selected image changing unit 115.

Next, processing when a folder is retrieved will be described.

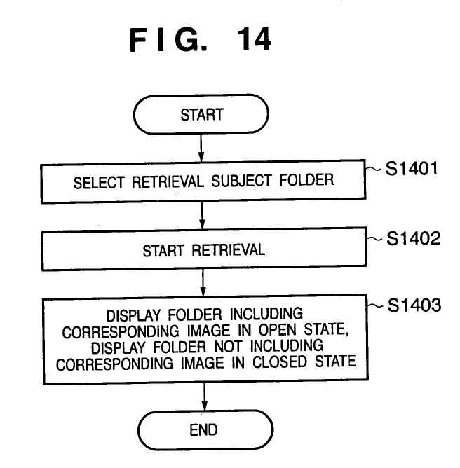

FIG. 14 is a flowchart showing a retrieval operation. At step S1401, the user selects a retrieval subject folder by using the input unit 101 via the folder selection unit 105. At step S1402, when the user requests to start retrieval, the image retrieving unit 113 retrieves image(s) satisfying a condition from the folder designated at step S1401. As an example of the retrieval, retrieval by keyword, date or the like can be used. When the retrieval has been completed, then at step S1403, folder(s) including image(s) satisfying the condition is displayed in an opened state while folder(s) not including image(s) satisfying the condition is displayed in a closed state. Since only folder(s) including image(s) satisfying the condition is open, only necessary folder(s) is open, thus the result of retrieval can be checked at a glance.

Next, processing when plural folders are selected in the tree area 200 will be described.

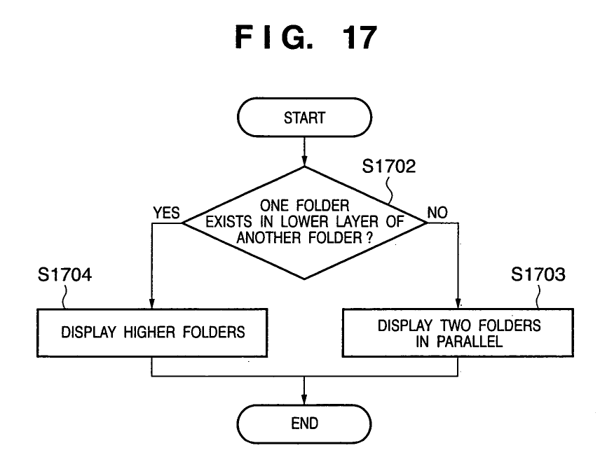

The processing corresponds to a function which is convenient when images included in plural folders are simultaneously displayed, or deletion or the like is performed simultaneously on plural folders. FIG. 17 is a flowchart showing processing when plural folders are selected. When the user selects plural folders using the input unit 101, the folder selection unit 105 detects the selection, and at step S1702, the folder arraying unit 107 determines whether or not one folder is lower than another folder. If it is determined that the one folder is not included in the other folder, the folder arraying unit 107 arrays the 2 folders in parallel.

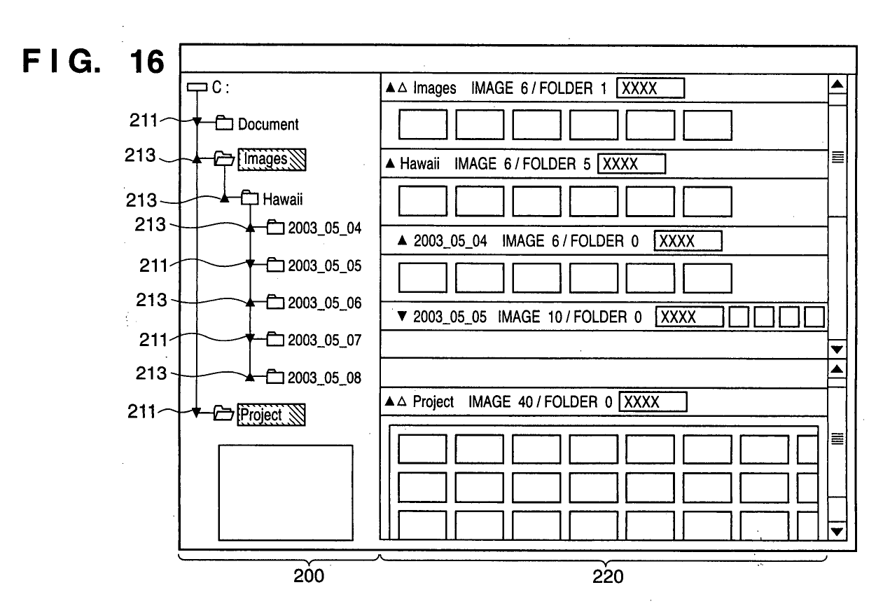

FIG. 16 is an example of screen image when two folders are displayed in parallel. In FIG. 16, the folder “Images” and a folder “Project” are selected. As one folder is not included in the other folder, the image list display area 220 is divided into upper and lower parts, and the folder structure below the folder “Images” is displayed in the upper part while the folder structure below the folder “Project” is displayed in the lower part. In this arrangement, plural folders can be compared with each other.

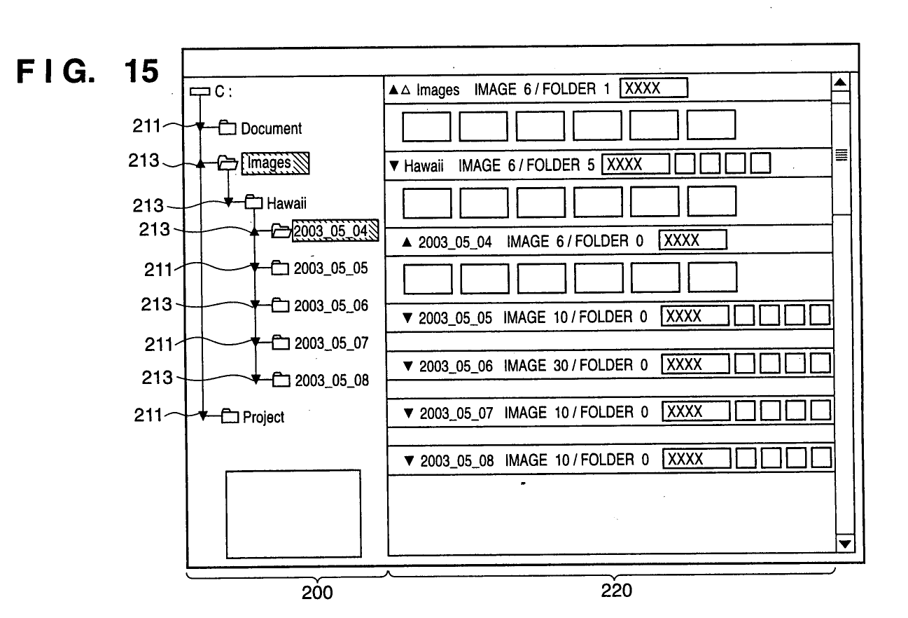

Returning to FIG. 17, if it is determined at step S1702 that one folder is included in the other folder, the folder included in the higher folder is displayed at step S1704. FIG. 15 is an example of screen image when a folder lower than a higher holder is displayed. In FIG. 15, the folder “Images” and a folder “2003_{—}05_{—}04” are selected. In this case, as the folder “Images” is higher than the folder “2003_{—}05_{—}04”, folders lower than the folder “Images” are displayed in the image list display area 220. In the example of FIG. 15, the selected folder is open, and the unselected folder is closed. In this arrangement, the user pays attention to only the selected folder. Further, the folder opening and closing buttons 211 and 213 in the tree area 200 reflect the folder opening/closed states.

In the above example, two folders are selected, however, a similar procedure can be used to display three or more folders. That is, a folder not included in other folders is displayed in parallel, but a folder included in another folder is displayed below the higher holder.

Note that in the present embodiment, only images can be selected in the image list display area 220, however, it may be arranged such that a second folder selection unit is provided so as to select a folder displayed in the image list display area 220. In such case, the folder selected by the second folder selection unit is also included in the selected image list, and the update processing or the like on the selected image list as shown at step S306 in FIG. 3 is also performed on the folder in the list.

According to the above-described embodiment, thumbnails of images in a sub folder can be displayed without changing a currently-selected folder, and the contents of plural folders can be simultaneously displayed. Accordingly, the contents of different folders can be easily compared with each other, and an image can be retrieved from plural folders without re-selection of folders. Further, as a folder not to be displayed can be closed, only folders the user wants to see can be compared and displayed.

Further, even if a folder is closed and then re-opened, a previously-selected image is displayed in the same selected state. Accordingly, it is unnecessary to select the image again.

Further, when another folder is selected, as the selected state of image included in a folder not lower than the folder is released, erroneous deletion of image existing a nondisplayed folder can be prevented.

Further, in a case where a selected image is included in a closed folder, as the folder is displayed in a different form from that of other folders, the user can easily recognizes that the selected image is included in the folder without opening the folder.

Further, in a case where a selected image is included in a closed folder, as a warning is made for the user upon image deletion, erroneous deletion can be prevented.

Further, as images are sequentially displayed from folder to folder, all the images managed by the user can be sequentially displayed with a simple operation.

Further, as only images included in open folder(s) are sequentially displayed, images included in folder(s) in which the user is interested can be sequentially displayed.

Further, as folder names are indented in accordance with the hierarchical structure, the folder hierarchical structure can be easily grasped, and images can be easily retrieved.

Further, regarding a closed folder, representative images are displayed. Accordingly, image retrieval can be made by analogical inference with the representative image as well as folder name as a key.

Further, as the number of images included in a folder and the number of folders are displayed, the user can obtain the number of images in the folder and the number of folders without counting the images and the folders.

Further, as a comment can be added to a folder and the comment can be displayed, a folder including a desired image can be found with the comment as well as folder name as a key.

Further, as the state of thumbnails existing immediately below a selected folder can be changed to a displayed or nondisplayed state, when the number of thumbnails immediately below a selected folder is large, the thumbnails can be turned to a nondisplayed state, and the area of screen image can be saved.

Further, upon retrieval, folder(s) including retrieved image is displayed in an open state, while folder(s) not including retrieved image(s) is displayed in a closed state. Accordingly, the user can recognize the folder(s) including the retrieved image(s) at a glance.

Further, as plural folders can be selected and plural thumbnails can be displayed, plural folders can be easily compared with each other. Further, when folders in hierarchical relation are selected, they are displayed in the same area. Thus the area of screen image can be saved.

Further, as a selected folder is displayed in an open state while an unselected folder is displayed in a closed state, the selected folder can be easily grasped. Further, only folder(s) in which the user is interested is displayed in an open state.

Further, as folder scrolling is made in the vertical direction while image scrolling is made in the lateral direction, the height of image display area can be set to a predetermined value, thus the area efficiency can be improved. Further, folder scrolling or image scrolling can be easily determined by scroll direction. When a mouse wheel function or the like is used, images can be scrolled by lateral scrolling in a state where the mouse cursor is located in a folder display area without moving the mouse cursor to an image area.

The present invention is not limited to the above embodiments and various changes and modifications can be made within the spirit and scope of the present invention. Therefore, to appraise the public of the scope of the present invention, the following claims are made.

### CLAIM OF PRIORITY

This application claims priority from Japanese Patent Application No. 2004-171772, filed on Jun. 9, 2004, which is hereby incorporated by reference herein.

1. An information management apparatus for managing information files by sorting said information files into folders, comprising:
selection means for selecting an arbitrary folder; and
folder operation means for individually opening/closing a sub folder immediately below said selected folder or in a lower layer.

2. The information management apparatus according to claim 1, further comprising:
folder display means for displaying plural folders with folder names; and
information display means for displaying thumbnails of said information files,
wherein said folder display means displays folder and folder name immediately below said selected folder, and folder and folder name immediately below a sub folder expanded by said folder operation means,
and wherein said information display means displays a thumbnail of an information file in said selected folder and a thumbnail of said sub folder.

3. The information management apparatus according to claim 1, wherein said selection means has second selection means for selecting information file and/or folder immediately below said selected folder,
and wherein, when a folder holding the information file and/or folder selected by said second selection means is closed by said folder operation means and then expanded again, a selected state of said selected information file and/or folder is maintained.

4. The information management apparatus according to claim 3, wherein, when a folder has been already selected by said selection means, if another folder is selected, said selected state is released regarding information file and/or folder selected by said second selection means in a lower layer of the newly selected folder.

5. The information management apparatus according to claim 4, wherein if the information file and/or folder selected by said second selection means exists in a folder closed by said folder operation means, said folder display means displays said folder in a different form from that of other folders.

6. The information management apparatus according to claim 5, wherein said folder display means displays said folder in a different color from that of said other folders or flash-displays said folder, as the different form from that of said other folders.

7. The information management apparatus according to claim 6, further comprising:
deletion means for deleting said information file and/or folder; and
means for, if the information file and/or folder selected by said second selection means exists in a folder closed by said folder operation means, issuing a warning upon deletion of said information file and/or folder.

8. The information management apparatus according to claim 4, further comprising:
third selection means for selecting an arbitrary information file by sequentially moving displayed information files; and
preview display means for displaying the information file selected by said second or third selection means,
wherein said third selection means sequentially selects an information file in another folder by moving from a folder of currently selected information file to another folder.

9. The information management apparatus according to claim 8, wherein said third selection means selects an information file only in a folder expanded by said folder operation means.

10. The information management apparatus according to claim 2, wherein, when said sub folder is expanded and its folder name is displayed, said folder display means produces a display with indentation in accordance with a hierarchical structure.

11. The information management apparatus according to claim 2, wherein, regarding an unexpanded sub folder, said folder display means displays a folder name and at least one of representative information files of the folder.

12. The information management apparatus according to claim 11, wherein said representative image information files are files from a head to a predetermined numbered file arrayed in the order of file name, files from the head to a predetermined numbered file arrayed in the order of image-sensing date and time, files from the head to a predetermined numbered file arrayed in the order of file update date and time, files from the head to a predetermined numbered file arrayed in the order of file size, or files from the head to a predetermined numbered file arrayed in the order of file type.

13. The information management apparatus according to claim 2, wherein said folder display means displays the number of information files in a displayed folder and the number of folders.

14. The information management apparatus according to claim 1, further comprising means for adding commentary information to said sub folder and displaying said sub folder,
wherein said commentary information is linked by folder.

15. The information management apparatus according to claim 2, wherein said folder operation means opens/closes a selected folder while maintaining an expanded/closed state of said sub folder,
and wherein when the selected folder is expanded, said information display means displays a thumbnail of an information file immediately below the folder, while when the selected folder is closed, said information display means turns the thumbnail to a nondisplayed state.

16. The information management apparatus according to claim 1, further comprising retrieval means for retrieving an arbitrary information file,
wherein said folder operation means expands a folder including a retrieved information file, and closes a folder not including a retrieved information file.

17. The information management apparatus according to claim 2, wherein said selection means is capable of selecting plural folders,
and wherein said folder display means displays folders in hierarchical relation, among selected folders, in the same area for visual recognition of the relation, and displays folders without the hierarchical relation in another area.

18. The information management apparatus according to claim 17, wherein said folder display means expands and displays a selected folder, and displays other folders in the closed state.

19. The information management apparatus according to claim 2, wherein when all the folders cannot be displayed in a display area, said folder display means displays said display area scrollably in upward and downward directions,
and wherein when all the information files cannot be displayed in a display area, said information display means displays said display area scrollably in a lateral direction.

20. An information management method for managing information files by sorting said information files into folders, comprising:
a selection step of selecting an arbitrary folder;
a folder operation step of opening/closing said selected folder;
a sub folder selection step of individually selecting a sub folder immediately below said selected folder or in a lower layer; and
an opening/closing step of individually opening/closing said selected sub folder.

21. The information management method according to claim 20, further comprising:
a folder display step of displaying plural folders with folder names; and
an information display step of displaying thumbnails of said information files,
wherein at said folder display step, folder and folder name immediately below said selected folder, and folder and folder name immediately below a sub folder expanded at said folder operation step, are displayed,
and wherein at said information display step, a thumbnail of an information file in said selected folder and a thumbnail of said sub folder are displayed.

22. The information management method according to claim 20, wherein said selection step includes a second selection step of selecting information file and/or folder immediately below said selected folder,
and wherein, when a folder holding the information file and/or folder selected at said second selection step is closed at said folder operation step and then expanded again, a selected state of said selected information file and/or folder is maintained.

23. The information management method according to claim 22, wherein, when a folder has been already selected at said selection step, if another folder is selected, said selected state is released regarding information file and/or folder selected at said second selection step in a lower layer of the newly selected folder.

24. The information management method according to claim 23, wherein if the information file and/or folder selected at said second selection step exists in a folder closed at said folder operation step, said folder is displayed in a different form from that of other folders at said folder display step.

25. The information management method according to claim 24, wherein at said folder display step, said folder is displayed in a different color from that of said other folders or flash-displays said folder, as the different form from that of said other folders.

26. The information management method according to claim 25, further comprising:
a deletion step of deleting said information file and/or folder; and
a step of, if the information file and/or folder selected at said second selection step exists in a folder closed at said folder operation step, issuing a warning upon deletion of said information file and/or folder.

27. The information management method according to claim 23, further comprising:
a third selection step of selecting an arbitrary information file by sequentially moving displayed information files; and
a preview display step of displaying the information file selected at said second or third selection step,
wherein at said third selection step, an information file in another folder is sequentially selected by moving from a folder of currently selected information file to another folder.

28. The information management method according to claim 27, wherein at said third selection step, an information file only in a folder expanded at said folder operation step can be selected.

29. The information management method according to claim 21, wherein, when said sub folder is expanded and its folder name is displayed, at said folder display step, a display is produced with indentation in accordance with a hierarchical structure.

30. The information management method according to claim 21, wherein, regarding an unexpanded sub folder, displays a folder name and at least one representative information files of the folder are displayed at said folder display step.

31. The information management method according to claim 30, wherein said representative image information files are files from a head to a predetermined numbered file arrayed in the order of file name, files from the head to a predetermined numbered file arrayed in the order of image-sensing date and time, files from the head to a predetermined numbered file arrayed in the order of file update date and time, files from the head to a predetermined numbered file arrayed in the order of file size, or files from the head to a predetermined numbered file arrayed in the order of file type.

32. The information management method according to claim 21, wherein at said folder display step, the number of information files in a displayed folder and the number of folders are displayed.

33. The information management method according to claim 20, further comprising a step of adding commentary information to said sub folder and displaying said sub folder,
wherein said commentary information is linked by folder.

34. The information management method according to claim 21, wherein at said folder operation step, a selected folder is opened/closed while an expanded/closed stated of said sub folder is maintained,
and wherein at said information display step, when the selected folder is expanded, a thumbnail of an information file immediately below the folder is displayed at said information display step, while when the selected folder is closed, the thumbnail is turned to a nondisplayed state.

35. The information management method according to claim 20, further comprising a retrieval step of retrieving an arbitrary information file,
wherein at said folder operation step, a folder including a retrieved information file is expanded, and a folder not including a retrieved information file is closed.

36. The information management method according to claim 21, wherein at said selection step, plural folders can be selected,
and wherein at said folder display step, folders in hierarchical relation, among selected folders, are displayed in the same area for visual recognition of the relation, and folders without the hierarchical relation are displayed in another area.

37. The information management method according to claim 36, wherein at said folder display step, a selected folder is expanded and displayed, and other folders are displayed in the closed state.

38. The information management method according to claim 21, wherein at said folder display step, when all the folders cannot be displayed in a display area, said display area is displayed scrollably in upward and downward directions,
and wherein at said information display step, when all the information files cannot be displayed in a display area, said display area is displayed scrollably in a lateral direction.

39. A program for executing the information management method according to claim 20 by a computer.
